(19) United States
(12) Patent Application Publication
(10) Pub. No.: US 2003/0225885 A1
(43) Pub. Date: Dec. 4, 2003

(54) Caching for limited bandwidth networks

(75) Inventors: Haim Rochberger, Tel Mond (IL); Yoram Mizrachi, Tel Aviv (IL)

Correspondence Address: SUGHRUE MION, PLLC, 2100 PENNSYLVANIA AVENUE, N.W., WASHINGTON, DC, 20037, US

(73) Assignee: COMVERSE, LTD.

(21) Appl. No.: 10/158,071

(22) Filed: May 31, 2002

(51) Int. Cl. G06F 15/173

(52) U.S. Cl. 709/226; 709/217

(57) ABSTRACT

A system and method for caching data, such as a Web page, for distribution to limited bandwidth devices, including but not limited to, wireless devices. A caching server causes to download at least a portion of the Web page in advance of a specific request by a Web client on the limited bandwidth device. The download request may be performed only “as needed” for a specific device, or may be performed in advance, for example in order to fulfill a predicted or expected need for a particular Web page. The requested data may be recorded and monitored in order to determine the most popular data being requested so that the caching server caches only that data deemed to be popular.

### FIELD OF THE INVENTION

The present invention is of a method and a system for caching in limited bandwidth devices and/or limited bandwidth networks, and in particular, of such a system and method for caching data in the wireless communication environment for improved performance characteristics.

### BACKGROUND OF THE INVENTION

Retrieval time for downloading data such as Web pages is a critical factor in the Internet environment for determining user satisfaction with a Web site, and also “stickiness”, or the ability of a Web site to induce users to repeatedly download data from the site. For e-commerce providers and other commercial Web site providers, the responsiveness of the Web site may at least partially determine whether users remain interested in a Web site, and hence the commercial success of the Web site. Thus, Web site owners wish to enhance the responsiveness of the Web site and increase the rapidity of downloading Web pages.

Currently, Web pages are typically downloaded according to the HTTP protocol, which defines only one process for downloading such pages. According to this process, the client (such as a Web browser for example) must first request the base Web page, and must then request all other subcomponents of the page in a linear or sequential manner. FIG. 1 illustrates a typical operation flow for retrieving Web pages according to HTTP. It should be noted that certain steps prior to downloading the Web page, such as resolving the name of the hosting server according to a DNS request, are not shown for purposes of clarity.

As shown, a Web client 10 first sends a base page request 12 to a Web server 14. Web server 14 then sends a base page reply 16 to Web client 10, which contains the base page for the requested Web page. Next Web client 10 sends a page component request 18 to Web server 14, which then sends a page component reply 20 to Web client 10. The latter request/response process may then be repeated, until all of the page components of the desired Web page have been downloaded.

This sequential request/response process may require a significant amount of time, particularly if each Web page component is requested separately only after the previous component has been received. In order to reduce the necessary download time, certain Web clients attempt to optimize the process by sending multiple page component requests simultaneously.

FIG. 2 is an example of such a system with multiple page requests prior to receiving page component replies. Such multiple requests can significantly increase the rate for downloading the Web page components. Assuming that the Web page has multiple components, performing a series of single, sequential request/response processes may require time (Rt) as follows:

Rt=2xCW

in which x is the number of components, and CW is the amount of time required for a single trip between Web client 10 and Web server 14. On the other hand, if Web client 10 can request multiple components simultaneously, then the amount of time may be reduced to the following:

Rt=2CW

Unfortunately, not all Web clients can request multiple components simultaneously. In particular, Web clients in the wireless environment may not be able to perform such multiple requests, as the device may only be able to perform one Transmission Control Protocol (TCP) or UDP connection at any given time. Also, the air interface may cause additional latency. In such a situation, the amount of time required to download a Web page may be significantly increased, as demonstrated in FIG. 3. In FIG. 3, Web client 10 is connected to Web server 14 through a proxy/mobile gateway 22. All of the communication between Web client 10 and Web server 14, including base page request 12, base page reply 16, page component request 18 and page component reply 20, must now pass through proxy/mobile gateway 22, thereby significantly increasing the download time. The response time (Rt) would therefore be calculated as follows:

Rt=xGW+xCG

in which x is the total items of the page, including the base page and components; CG is the time from Web client 10 to proxy/mobile gateway 22 and then back to the Web client 10; and GW is the time from proxy/mobile gateway 22 to Web server 14 and back to the gateway 22.

Even if proxy/mobile gateway 22, in parallel, requests the remaining (x−1)GW requests to Web server 14, these pages would still be delayed in their delivery to Web client 10.

Clearly, the wireless Web page download response time may potentially be much longer than for regular or wired Internet connections which need not travel through a proxy/gateway component, particularly given the additional delay which may be caused by the air interface and other factors related to the wireless environment.

### SUMMARY OF THE INVENTION

According to a preferred embodiment of the present invention the deficiencies attendant with the background art are overcome by providing a system and method for caching data for distribution to, for example, limited bandwidth devices, including but not limited to, wireless devices, which may also include geographically and/or content sensitive caching. Data may be cached in order to increase the rate of data transfer, but may also be cached in order to increase other performance characteristics. This embodiment of the invention provides a caching server to download at least a portion of the Web page in advance of a specific request by a Web client via a limited bandwidth device. The download request may optionally be performed only “as needed” for a specific device, or alternatively may be performed in advance, for example in order to fulfill a predicted or expected need for a particular Web page. The caching server is preferably located in near proximity to the limited bandwidth device, for maximum efficiency in data transmission.

According to another preferred embodiment of the present invention, there is provided a method for caching content in a distributed environment according to geographic and/or content-sensitive characteristics, through a caching server and a plurality of proxies. For example, only the popular Web sites and/or pages in a distributed environment may be cached. This reduces the amount of necessary cache which, in a practical sense may be limited because of size. For example, after a certain size, the search and management of the cache can compromise its effectiveness and therefore it is desirable to limit the cache's size. The Caching Server according to this embodiment relieves the Gateway itself from the heavy burden of managing the cache.

According to this embodiment, geographic sensitivity may also be included for determining both the type and location of content to be cached. For example, the popularity of certain types of content may be related to particular locations. According to a preferred embodiment of the present invention, the caching server is the gateway for the limited bandwidth device, through which the device must perform a request for Web page(s) and/or Web page component(s). Since all such requests must pass through the gateway, caching data at the gateway clearly results in increased performance.

According to another preferred embodiment of the invention, the gateway maintains a popularity table for determining which data should be cached.

According to another embodiment of the present invention, there is provided a method for caching data for delivery from a content server to a limited bandwidth device, the data featuring a plurality of components, the method comprising:

providing a gateway for communicating between the content server and the limited bandwidth device;

requesting a first component by the limited bandwidth device in a first request to the gateway;

passing the first request by the gateway to the content server;

requesting at least one additional component by the gateway to the content server; and

caching, at the gateway, the at least one additional component from the content server.

According to another embodiment of the present invention, there is provided a system for caching data, the data comprising a plurality of components, the system comprising:

(a) a limited bandwidth device for requesting a first component in a first request and a second component in a second request;

(b) a content server for providing the first component and the second component upon receiving the first and the second request, respectively;

(c) a gateway for receiving the first request from the limited bandwidth device and for providing the first component from the content server to the limited bandwidth device, and receiving the second component from the content server before receiving the second request from the limited bandwidth device, and waiting to provide the second component to the limited bandwidth device until the gateway receives the second request.

According to still another embodiment of the present invention, there is provided a method for caching data for delivery from a content server to a limited bandwidth device, the data featuring a plurality of components, the method comprising:

detecting requests for the data; rating a popularity for the data according to a number of requests; and

if the popularity is above a predetermined threshold, then caching the data for transmission to the limited bandwidth device.

Hereinafter, the term “limited bandwidth device” refers to a device in which a connection for downloading data, such as a network, has a limited bandwidth and/or in which a device is only capable of forming a single such connection at any given time, and therefore the device is limited in bandwidth. A non-limiting, illustrative example of a limited bandwidth device is a wireless device, such as a cellular telephone. Hereinafter, the term “cellular telephone” is a wireless device designed for the transmission of various types of data and/or analog signals. Non-limiting examples of such data include text data, graphical data, audio data (including voice data), video data, and “documents” described in a “mark-up” language.

### BRIEF DESCRIPTION OF THE DRAWINGS

The invention is herein described, by way of example only, with reference to the accompanying drawings, wherein:

FIG. 1 is a schematic block diagram showing a known system for a direct Web page request;

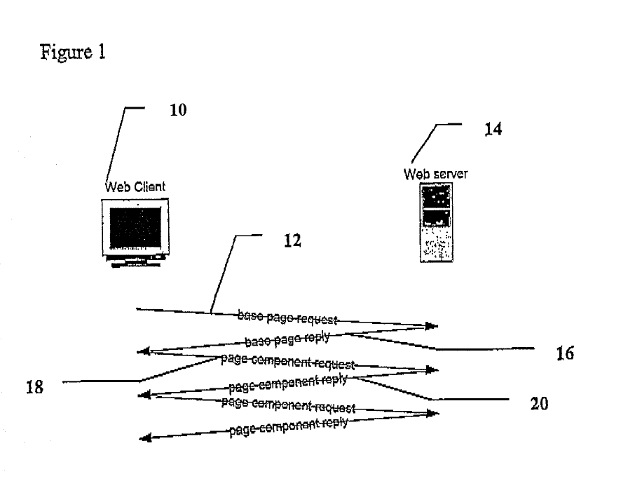

FIG. 2 is a schematic block diagram showing a known system for requesting a Web page through a gateway;

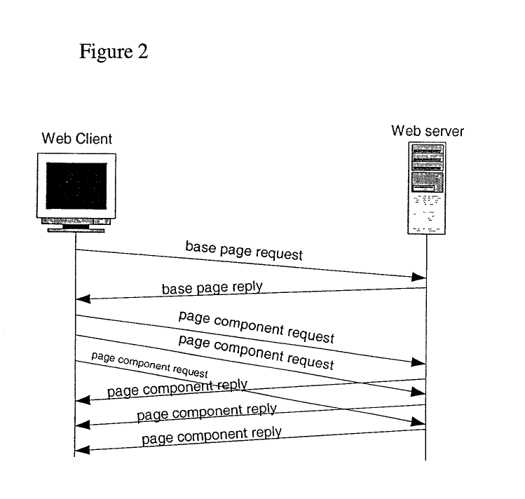

FIG. 3 is a schematic block diagram showing a known system for requesting Web pages through a gateway;

FIG. 4 is a schematic block diagram showing a system operation according to an embodiment of the present invention for data caching at a gateway;

FIG. 5 is a schematic block diagram showing a system according to an embodiment of the present invention for data caching according to a router; and

FIG. 6 shows a schematic block diagram of a caching flow of operations according to an embodiment of the present invention.

### DESCRIPTION OF THE PREFERRED EMBODIMENTS

The principles and operation of a method and a system according to the present invention may be better understood with reference to the drawings and the accompanying description.

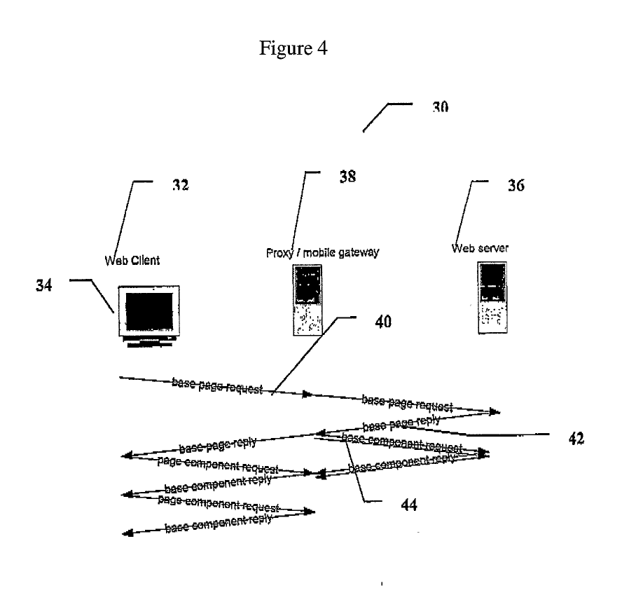

Referring now to the drawings, FIG. 4 shows an exemplary implementation of a system 30 according to an embodiment of the present invention. System 30 features a Web client 32 which is operated by a limited bandwidth device 34. Web client 32 is able to request pages from a Web server 36, but only through a proxy or mobile gateway 38. Gateway 38 may also be required for translating requested Web pages from one type of mark-up language to another type of language, such as from HTML (HyperText Mark-up Language) to WML (Wireless Mark-up Language), for example. Alternatively or additionally, gateway 38 may perform other functions within system 30. For example, gateway 38 may perform such functions as billing, access control, virus scanning, and advertisement insertion. According to one embodiment of the present invention, gateway 38 includes a cache for caching web pages. In general, caching of web pages is known, for example, from the HTTP 1.1 Standard, which is incorporated herein by reference. However, according to this embodiment of the invention, the gateway cache automatically retrieves several components of each requested Web page, once Web client 34 has requested only the base page from Web server 36. Specifically, gateway 38 determines when such a Web page has been requested by Web client 34, for example by detecting a request for the base page. Gateway 38 then communicates directly with Web server 36 to retrieve not only the requested base page, but also the remaining components of the Web page (although these remaining components have not yet been requested by the Web client 34). The remaining components are then cached at the gateway 38 and subsequently delivered to limited bandwidth device 32 when they are subsequently requested by Web client 34. The components may be temporarily stored at the gateway cache so as to utilize efficiently the cache's storage capacity. For example, after a component is provided to the Web client from the gateway 38, the component is deleted from the cache. FIG. 4 shows an exemplary but preferred flow operation diagram for performing such a direct retrieval of the remaining components by gateway 38. As shown, Web client 34 sends a base page request 40 through gateway 38 to Web server 36. A base page reply 42 is sent from Web server 36 through gateway 38 to Web client 34. Next, gateway 38 automatically sends a page component request 44 directly to Web server 36, without waiting for Web client 34 to transmit such a request. Web server 36 sends a page component reply 46 to gateway 38, containing the requested component, and the component is cached at the gateway. Therefore, when Web client 34 subsequently sends a page component request 48 to gateway 38, gateway 38 answers page component request 48 directly with a page component reply 50, retrieves the component from the gateway's cache, and transmits that component to limited bandwidth device 32. Thus, according to this embodiment when client 34 sends the page component request, gateway 38 already has the requested page component in its cache and need not retrieve the component from the web server 36, thereby reducing the download time.

This process is repeated as shown in FIG. 4, until limited bandwidth device 32 has received all of the Web page components. As indicated above, in order to conserve storage capacity, gateway 38 only temporarily stores the Web page components, at least until Web client 32 has requested all such components. That is, as Web client 32 acknowledges receipt of each component, the component is discarded by gateway 38. This ensures sufficient resources for storing the Webpage components.

The operation of caching such Web page components increases the efficiency of transmission of the Web page components according to the following calculation:

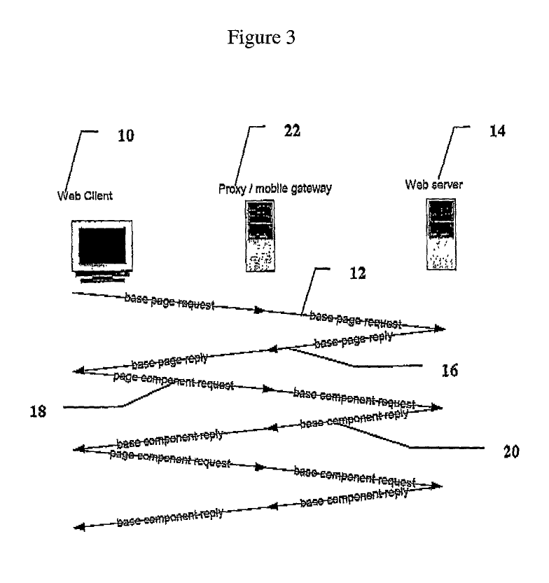

Rt=GW+xCG

in which x is the total items of the page, including the base page and components for each direction of the transmission; CG is the time from Web client 32 to gateway 38; and GW is the time from gateway 38 to Web server 36. As an example, if there are five components in a Web page (including the base page), CG (time from Web client 32 to gateway 38) is 2 seconds, and GW (time from gateway 38 to Web server 36) is 1 second, then according to the known system of FIG. 3, the time to retrieve the Web page is 15 seconds (Rt=5*2+5*1). According to the embodiment of the invention shown as system 30 in FIG. 4, however, the time to retrieve the same Web page is just 11 seconds (Rt=1+5*2), which is a significant decrease in the retrieval time.

According to another embodiment of the invention, proxy or gateway 38 keeps track of popular Web pages or URLs, and based on the popularity of a particular Web page or URL, determines whether that URL or Web page should be cached. In order to perform these functions, the proxy or gateway manages two look-up table or other databases, one is a popularity table or database, and the other is a cached URL/Web page table or database.

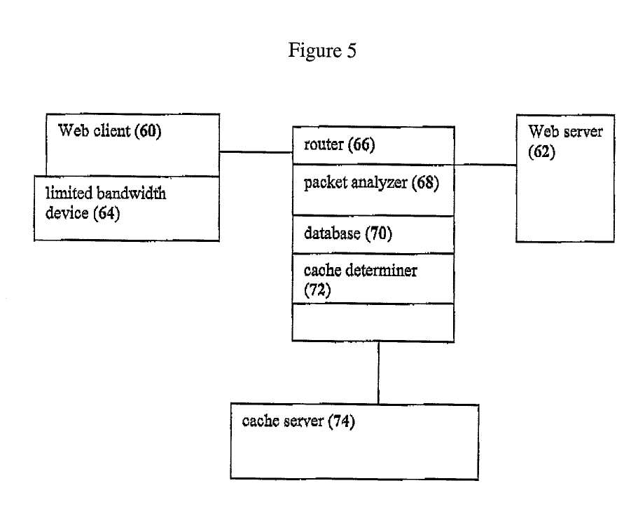

FIG. 5 shows a block diagram according to this embodiment of the invention. As shown in FIG. 5, the gateway or proxy 66 includes a packet analyzer 68, a database 70, and a cache determiner 72. The gateway or proxy is also in communication with a cache server 74. The Web client 60 causes a request to be sent from limited bandwidth device 64 to Web server 62 through the gateway or proxy 66. The packet analyzer 68 analyzes received packets (e.g., by examining the header information of packets), and identifies those packets which are requests, or REQ, packets for an HTTP session. Packet analyzer 68 then extracts the URL (service) from the packet, and adds or counts the fact that the URL was requested to a look-up table or database 70. The purpose of this database or look-up table 70 is to keep track of all requested URLs in order to determine which URLs are popular. As discussed in more detail below, the cache determiner 72 at gateway/proxy 66 determines which URLs are most popular, according to, for example, a popularity scale. The popularity table 70 is managed locally at the gateway 66 and is filled by counting, per a unit of time, the number of hits to a particular URL. The hits are counted with a timestamp so the table is filled with URLs, each with information representing how many hits of that URL occurred in the last day, the last hour, the last minute, etc. The popularity table operates according to a predetermined threshold as to what is considered a popular URL. For example, the table can be configured such that, for example, the 500 most often requested URLs are considered “popular”. In another example, the popular status can be applied to any URL that has a hit count of more than a predetermined number (e.g., 50) in the last predetermined unit of time (e.g., hour). Additional or alternative mechanisms for determining the popularity of each URL may be employed. Another non-limiting example for determining the popularity of each URL may be found at http://www.usenix.org/publications/library/proceedings/usits97/full_papers/dou glis_rate/douglis_rate_html/douglis_rate.html.

Regardless of the criteria used to determine popularity, each URL has a status field indicating whether or not the URL is popular.

After a particular URL meets the predefined criteria to be considered sufficiently popular (i.e., the status field of the particular URL indicates that it is popular), cache determiner 72 sends a request to a cache server 74, for retrieving the Web page or other information at the popular URL from Web server 62, in order to be able to cache this Web page.

In the above examples, popularity of a Web page is determined based on the number of actual hits, however, popularity may also be determined based on expected hits of a Web page, as is described below.

When a URL is requested (using a GET or POST HTTP), it may counted with a certain number of points (e.g., for each hit within one hour, the URL is awarded 100 points of popularity). In the embodiment in which points of popularity are awarded, a popular URL may be defined as a URL having a certain number of points of popularity (e.g., 10,000). When the cache server 74 retrieves the Web page from Web server 62, the gateway retrieves the Web page to a predetermined depth. That is, each Web page may have links to other Web pages, which in turn may have additional links, such that retrieving the Web page to a predetermined depth may involve retrieving each linked page recursively, until a predetermined level of Web pages is reached. For example, in HTML, the gateway 66 can use the href attribute to identify links within the URL to other URLs. When obtaining such a URL link, the system may award to that URL link a certain popularity value (e.g., instead of 100 points of popularity for a direct URL hit, the system may award some faction of the total points, such as 50 points of popularity for each URL link identified). Accordingly, a linked URL may reach “popular” status for caching purposes even if in theory, it was not directly requested at all (e.g., because the URL was linked to an extremely popular URL and therefore accumulates a large number of popularity points). As indicated above, various criteria may be used to define a popular site, and if desired, a further criteria may be defined such that a popular site will not be cached unless it was directly requested. For example, a URL that has not been directly requested but is otherwise defined as popular (i.e., it has sufficient points to qualify as popular), may been deemed as “tentative popular”, and will not be cached until and unless that URL is directly requested. Alternatively, no such criteria need be defined such that an otherwise popular URL that has never been directly requested will be cached in cache server 74.

Accordingly, the popularity table according to this embodiment is dynamic, and the status (i.e., cached or not cache) of URLs in the table may change with time (e.g. a URL that becomes popular will be cached at cache server 74, and a popular URL that does not remain popular will be deleted from the cache server 74). The status of URLs in the table may also change in accordance with URL traffic (i.e., a URL will become popular if it requested “often” as that term is defined by the user, and a popular URL will lose that status and be deleted from the Cache Server 74 if it is not requested “often”).

Besides maintaining a popularity table, the gateway 66 also maintains a Cached URL table. Specifically, after the cache determiner 72 sends a request to the cache server 74 to cache a popular web page, it adds that web page to a Cached URL table (i.e., a table or list of cached Web pages). The Cached URL table may be located in the gateway, but the table may be managed by the Cache Server 74. Accordingly, the Cached URL table may be “read only” for the gateway or proxy 66. The Cached URL table contains a list of URLs that are cached at the local cache server 74 (which could be a bank of servers managed by one or more control units).

Accordingly, when a gateway 66 identifies a request for a specific URL, in addition to managing the popularity table based on the request, the gateway also determines whether or not the requested URL is contained in the Cached URL table. If the requested URL is found in the Cached URL table, then cache determiner 72 determines that the cached Web page should be retrieved from cache server 74, rather than retrieving the Web page from the Web server 62, thereby reducing Web page download time. In another embodiment of the invention, cache determiner 72 may permit only a restricted number of URLs or other service indicators to be stored at database 70, such that less popular URLs may be replaced from database 70 if a sufficient number of more popular URLs are detected. For example, Cache Determiner 72 may cause cache server 74 to cache only the top 100 most popular Web pages, and deleting any Web page that does not make the top 100. Also, the stored URL may be managed by a timing function, such that once a URL has been stored for a certain period of time, cache determiner 72 automatically removes the URL from database 70. However, if the URL remains popular (e.g., the URL is requested prior to the expiration of the certain period of time), then it may then be reinserted into database 70.

According to another preferred embodiment of the present invention, the initial request for a Web page may be sent from Web client 60 to Web server 62. The gateway or proxy 66 then detects that the components of the requested Web page are stored at cache server 74, and routes requests for the additional components and/or additional links to cache server 74.

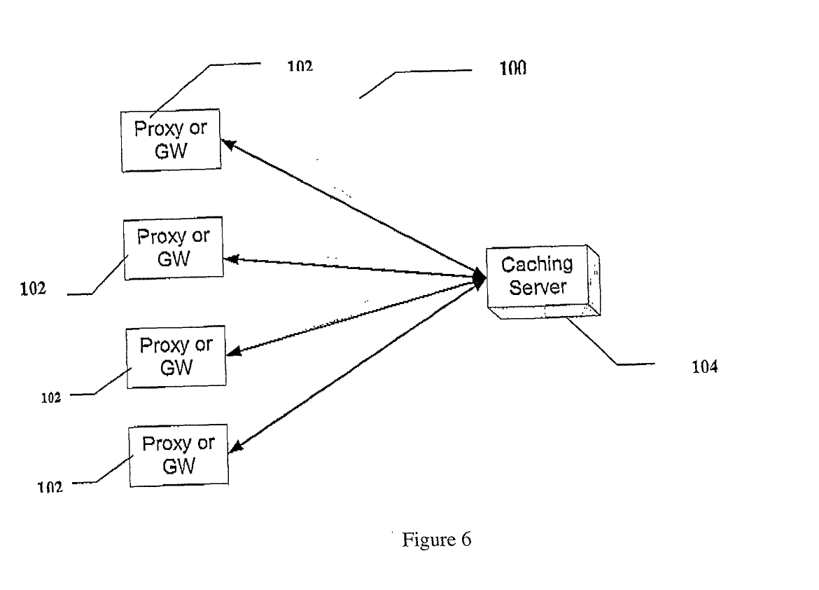

FIG. 6 shows a schematic block diagram of a flow of operations according to another embodiment of the present invention. The embodiment shown in FIG. 6 includes a system 100 with a plurality of proxies 102, which may function as gateways. Each proxy 102 is also in communication with a caching server 104. Each proxy 102 preferably maintains a table of “popularity”, as an example of one type of content sensitive characteristic, as discussed above. One non-limiting example of an entry in such a table is shown below:

| | | | # of | | | |
|---|---|---|---|---|---|---|
| | | Total # | hits | # of | | |
| | | of hits | at | hits | # of | |
| | Last | Since | the | at the | hits at | |
| | updated | last | last | last | the last | Cache |
| URL | seq # | reboot | Day | hour | Minute | State |
| www.xyz.com | 1230 | 120 | 50 | 20 | 5 | YES |

In this example, the URL www.xyz.com is listed in the table, along with user information, such as the total number of hits since: the last reboot of the gateway or proxy, within the last day, within the last hour, and within the last minute. The table also indicates that the URL (www.xyz.com) is cached at the Caching Server 104. Further, the table indicates the last updated sequence number for the URL (1230). The benefits of such a sequence number is discussed in more detail below.

Similar to the popularity table discussed above, if a particular URL exceeds a predetermined threshold, then that URL is considered popular, and will be cached at the Caching Server 104. For example, the system can configure the 500 most popular URLs in accordance with the data contained in the table or consider a URL is popular if it's the URL has a hit count that exceeds, for example, 50 within the last hour).

After a Web page is considered popular (e.g., a predetermined number of hits within a time period), this Web page is added to the list maintained in the Proxy or Gateway as a cached Web page. Conversely, fewer than a minimum number of hits per time period would have the opposite effect. That is, the Web page would not be cached, or if cached, then the unpopular Web page would be deleted.

As was mentioned, each of the Gateways 102 in FIG. 6 “commands” the Cache Server 104 to cache a URL once that URL is determined to be “popular” by one of the Gateways.

Once the Cache Server 104 receives that “command” from one of the Gateways 102 to cache a URL, then the Cache Server 104 is responsible for maintaining the URL's “freshness”. In this regard, the Cache Server sends to each of the Gateways 102 a “Cache list” of all the URLs it is maintaining (with sequence number)

In the embodiment of FIG. 6, a situation could arise in which more than one Gateway 102 commands the Caching Server 104 to cache a particular URL. In this situation, the Cache Server 104 maintains for each cached URL a list of each of the Gateways 102 that “commanded” the URL to be cached. For example, the URL www.xyz.com may be requested (determined to be “popular”) by two different Gateways 102. Below are exemplary situations in which a particular URL is deleted by the Cache Server 104 in FIG. 6.

If the Cache Server 104 identifies that one of the Gateways 104 is down (i.e., inoperable), then after a predefined timeout (for example 20 minutes) the Cache Server examines all of the cached URLs, and for those URLs that were “commanded” to be cached by that down or inoperable Gateway, the Cache Server 104 removes that Gateway from the Cache list. If that URL's Cache list becomes empty (i.e. no other Gateway “commanded” the Caching Server 104 to cache the URL), then the URL is deleted.

1) If a specific Gateway “commands” that a URL which was previously popular by that Gateway is now deemed “unpopular”—then the Cache Server 104 removes that Gateway from the above Cache list, and only if there is no other Gateway for that entry on the Cache list (meaning no other Gateway “commanded” that the URL be cached) then the URL is deleted from the cache.

There could be a situation where a Gateway “commands” Caching Server 104 to cache a URL—but in respnse receives a failed reply, such as “Cache is full”. In this case, the Gateway has the choice to choose a URL (that was previously “commanded” to be cached)- to be deleted so that the Caching Server has storage room to insert the new URL instead. Such a URL deletion would only be permitted if the URL to be deleted was commanded to be cached by the presently requesting GW 104. In this situation, the Cache Server 104 provides a list of URLs that the presently requesitng Gateway has commanded to be cached so it can determine whether or not the URL can be deleted (i.e., by determining whether or not the URL is on this list of URLs). Each time a URL changes state (from popular to non-popular or vice-versa), proxy 102 instructs Caching Server 104 to either cache the content or to remove the content from the cache. The protocol is preferably operated as a confirmed protocol, and once the confirmation arrives, the table entry's cache state would change (YES/NO).

Caching Server 104, upon receipt of a command from a proxy 102 to cache a URL (e.g., because it has become “popular”), would preferably retrieve the associated content from the Web server, and then cache the page, and notify proxy 102, according to, for example, the HTTP cache rules. If the URL was requested, then the URL from the Web server would also be directed to the Proxy or Gateway that requested the URL so it can be forwarded on to the web client.

Once the URL is cached, it is the responsibility of the Caching Server 104 to maintain the validity of the cache data. For example, the Cache Server 104 would periodically refresh the cached content, as is well known in the art. Each time the content of the Caching Server 104 is updated, a new sequence number is sent to the proxies/gateways 102. Each of the proxies/gateways has its own local cache, and the local cache will store URLs (along with the sequence number) that have been recently requested. If a proxy/gateway receives a request for a URL and that URL is cached both in the local cache of the proxy/gateway and in caching server 104, then the Cache Determiner will determine whether the last updated sequence number in the popularity table for the URL matches the sequence number for the URL stored in the local cache, and if the two sequence numbers do not match, (indicating that the URL stored in the local cache is stale), then the URL from the Caching Server 104 is retrieved, and the locally cached URL is deleted. If on the other hand the URL sequence number located in the local cache matches the sequence number listed in the popularity table, then the URL stored in the local cache is considered “fresh” and therefore retrieved instead of retrieving the URL from the Caching Server 104. The fact that the two sequence numbers match means that the caching server 104 did not refresh the contents of this URL since it was stored in the local cache. Of course, there may be situations in which a requested URL is stored in the local cache of the proxy/gateway but is not stored in the caching server 104 (e.g., for example, the requested URL is not considered popular although it was recently requested at the same proxy/gateway and thus is stored in the local cache). In this case, some other provision must be used to determine whether the locally cached URL needs to be refreshed (e.g., such as a predetermined time period after which a URL stored in a local cache is no longer considered fresh).

It will be appreciated that the above descriptions are intended only to serve as examples, and that many other embodiments are possible within the spirit and the scope of the present invention.

What is claimed is:

1. A method for caching data for delivery from a content server to a limited bandwidth device, the data featuring a plurality of components, the method comprising:
providing a gateway for communicating between the content server and the limited bandwidth device;
requesting a first component by the limited bandwidth device in a first request to said gateway;
passing said first request by said gateway to the content server;
requesting at least one additional component by said gateway to the content server before the limited bandwidth device requests said at least one additional component from said gateway; and
caching said at least one additional component by said gateway.

2. The method of claim 1, wherein said at least one additional component is transmitted to the limited bandwidth device by said gateway after the limited bandwidth device requests said at least one additional component in a second request, such that said second request of the limited bandwidth device is retrieved from said cached content of said gateway.

3. The method of claim 2, wherein the limited bandwidth device is only able to transmit a single request to said gateway before a component is returned to the limited bandwidth device.

4. The method of claim 1, further comprising:
transmitting said first component by said gateway to the limited bandwidth device; and
requesting a plurality of said additional components by said gateway in parallel to transmitting said first component.

5. The method of claim 1, wherein said gateway stores each received component from the content server in a cache, and wherein said gateway removes said received component from said cache after said received component is transmitted to the limited bandwidth device.

6. The method of claim 1, wherein the limited bandwidth device is a wireless device.

7. The method of claim 6, wherein the limited bandwidth device is a cellular telephone.

8. The method of claim 1, wherein all requests from the limited bandwidth device to the content server are transmitted through said gateway.

9. The method of claim 1, wherein the data is stored at said gateway according to at least one characteristic of the data.

10. The method of claim 9, wherein said at least one characteristic is a popularity of the data, such that the data is stored at said gateway according to a frequency of requests for the data.

11. The method of claim 10, wherein the content server communicates with a plurality of gateways, and wherein each gateway stores a same table indicating the popularity of data.

12. The method of claim 11, wherein the data is a Web page and the content server is a Web server.

13. A system for caching data, the data comprising a plurality of components, the system comprising:
(a) a limited bandwidth device for requesting a first component in a first request and a second component in a second request;
(b) a content server for passing said first component and said second component upon receiving said first and said second request;
(c) a gateway for receiving said first request and said second request, and for passing said first component to said limited bandwidth device, and caching the second component and waiting to pass said cached second component until said gateway receives said second request from said limited bandwidth device.

14. The system of claim 13, wherein the limited bandwidth device is a wireless device.

15. The system of claim 14, further comprising:
(d) a cache server for communicating with said content server and with said gateway, wherein said gateway determines whether the data is cached at said gateway.

16. The system of claim 15, further comprising a plurality of gateways, each gateway maintaining a same table indicating the popularity of the data, and when data is deemed popular according to a predefined criteria, causing the popular data to be cached at the cache server.

17. The system of claim 16, wherein each gateway includes a local cache for storing data.

18. A method for caching data for delivery from a content server to a limited bandwidth device, the method comprising:
detecting requests for the data;
rating a popularity for the data according to a number of requests; and
if said popularity is above a predefined threshold, then caching the data for transmission to the limited bandwidth device.

19. The method according to claim 18, wherein the predefined threshold of popularity is at least one of: the number of requests for the data within the last day, the number of requests for the data within the last hour, the number of requests within the last minute, and the number of requests within the last minute.

20. The method according to claim 18, wherein if data is cached, and the data is requested by a limited bandwidth device, then the data is retrieved from the cache and transmitted to the limited bandwidth device.

21. The method according to claim 18, wherein the data is a URL, and the cached URL is cached in a cache server.

22. A system for retrieving a page of information, the information comprising a plurality of components, the system comprising:
a gateway configured to receive a request for a first component of the page of information and a subsequent request for a second component of the page of information; transmit said first component in response to the request for the first component, and caching the second component and waiting to transmit said cached second component until said gateway receives said subsequent second request.

23. The system according to claim 22, further comprising a content server for storing the page of information, and wherein said gateway receives the first and second components from said content server.

24. The system according to claim 22, further comprising a client for requesting the page of information.

25. The system according to claim 22, wherein the page of information is a Web page.

26. The system according to claim 23, wherein the page of information is a Web page.

27. The system according to claim 24, wherein the page of information is a Web page.

28. The system according to claim 22, further comprising a limited bandwidth device for requesting the page of information.

29. The system according to claim 28, wherein the limited bandwidth device is a mobile phone.

30. The system according to claim 29, wherein the page of information is a Web page.

31. A method of caching a page of information, comprising:
tabulating requests for a page of information to determine whether the page of information meets a predefined popularity criteria; and
if the page of information meets the predefined popularity criteria, then caching the page of information.

32. The method according to claim 31, wherein the page of information is a Web page.

33. The method according to claim 31, wherein if the page of information no longer meets the predefined popularity criteria, then deleting the page of information from the cache.

34. The method according to claim 31, wherein the page of information is cached, the page of information is subsequently requested and the cached page of information is retrieved.

35. The method according to claim 31, wherein a limited bandwidth device requests the page of information.

36. The method according to claim 34, wherein the page of information is Web page.
